(19) United States
(12) Patent Application Publication
(10) Pub. No.: US 2013/0339073 A1
(43) Pub. Date: Dec. 19, 2013

(54) INFLUENCING THE UTILIZATION OF RESOURCES IN A CIRCUMSCRIBED VENUE

(71) Applicant: Alan Dabbiere, McLean, VA (US)

(72) Inventor: Alan Dabbiere, McLean, VA (US)

(73) Assignee: AIRWATCH, LLC, Atlanta, GA (US)

(21) Appl. No.: 13/495,644

(22) Filed: Jun. 13, 2012

(51) Int. Cl. G06Q 10/06

(52) U.S. Cl. 705/7.12

(57) ABSTRACT

Disclosed are various embodiments for influencing the utilization of resources in a circumscribed venue. In one embodiment, a computer-based optimization service identifies resources associated with a circumscribed venue. The optimization service determines the optimal utilization of the venue resources based on venue-specific and participant-specific variables. The optimization service transmits optimization data based on the optimal utilization to client devices associated with venue participants.

### BACKGROUND

Places of consumer interest, or venues, are often circumscribed by constraints that determine the boundaries of the venue. Examples of circumscribed venues include amusement parks, zoos, sporting arenas, convention centers, campuses, shopping malls, theatres, cruise ships, airplanes, and other venues circumscribed by physical, virtual or economic constraints. Circumscribed venues often have multiple resources that consumers, or venue participants, may access. Typically, the distribution of venue participants across venue resources is not necessarily equal. Venue resources that are more popular or more important to venue participants are accessed more frequently. The unequal utilization of venue resources diminishes both the profitability of the circumscribed venue and the satisfaction, or value, experienced by venue participants. For example, venue participants waiting to access venue resources are not contributing to the circumscribed venue's revenue stream, are often inconvenienced by the wait for access to the venue resources, and are limited in accessing additional resources due to time constraints. Implementing a means for influencing the utilization of resources in a circumscribed venue is therefore desirable.

To date, circumscribed venues have sought to influence, or enhance, venue participation by distributing a combination of participant-based optimization data and venue-specific map data to client devices associated with venue participants, based at least in part on the location of the client devices. The former method's inclusion of map data creates an unnecessary burden on the venue participants associated with the client devices. More specifically, venue participants do not always require map data in order to utilize the distribution of optimization data. For example, a venue participant may already know the location of the venue resources or may be within visual proximity of the venue resources, and the distribution of map data is therefore unnecessary and burdensome to the venue participant accessing the optimization data. Additionally, the former method's inclusion of map data creates an unnecessary burden on the network operations of the circumscribed venue. More specifically, the map data is merely provided to the venue participants in combination with the optimization data rather than, for instance, providing a basis for the determination of which optimization data to transmit to the venue participants. Map data, or graphical representations of the circumscribed venue, may require large amounts of data storage and network bandwidth to transmit such map data from a computer-based service to client devices. On the contrary, optimization data alone may not impose such storage and transmission burdens on the circumscribed venue's network operations as the optimization data may merely include simple text. Consequently, the present disclosure is preferable over the former methods as it influences the utilization of resources in a circumscribed venue while minimizing the impact imposed on the circumscribed venue and its associated participants.

### SUMMARY OF THE INVENTION

Disclosed are embodiments for a computing device configured to execute a computer-based optimization service for influencing the utilization of resources in a circumscribed venue. The optimization service comprises logic that determines which resources are within the circumscribed venue, logic that determines the optimal utilization of the venue resources, and logic that transmits optimization data to client devices associated with venue participants.

Disclosed are embodiments for a computer-based method for influencing the utilization of resources in a circumscribed venue. The method comprises transmitting data communications from client devices to a computer-based optimization service, receiving optimization data associated with venue resources on the client devices, and rendering the optimization data on the client devices.

Disclosed are embodiments for a non-transitory computer-readable medium embodying a program executable in a computing device for influencing the utilization of resources in a circumscribed venue. The medium comprises code that determines the status of the inventory of venue resources, code that identifies incentives based at least in part on the inventory status, and code that transmits the incentives to client devices associated with venue participants.

### BRIEF DESCRIPTION OF THE DRAWINGS

Many aspects of the present disclosure can be better understood with reference to the following diagrams. The drawings are not necessarily to scale, emphasis instead being placed upon clearly illustrating certain features of the disclosure. Moreover, in the drawings, like reference numerals designate corresponding parts throughout the several views.

FIG. 1 is a block diagram of a networked environment of a circumscribed venue according to certain exemplary embodiments of the present disclosure.

FIG. 2 is a flowchart illustrating exemplary functionality performed by a computer-based optimization service executed by an optimization server in the networked environment of FIG. 1 according to certain embodiments of the present disclosure.

FIG. 3 is a flowchart illustrating exemplary functionality performed by one or more client devices in communication with a computer-based optimization service executed by an optimization server in the networked environment of FIG. 1 according to certain embodiments of the present disclosure.

FIG. 4 is a flowchart illustrating exemplary functionality performed by a computer-based optimization service executed by an optimization server in the networked environment of FIG. 1 according to certain embodiments of the present disclosure.

FIG. 5 is a flowchart illustrating exemplary functionality performed by a computer-based optimization service executed by an optimization server in the networked environment of FIG. 1 according to certain embodiments of the present disclosure.

FIG. 6 shows schematic block diagrams illustrating an optimization server and client device employed in the networked environment of FIG. 1 according to certain embodiments of the present disclosure.

### DETAILED DESCRIPTION

Disclosed are various embodiments for a system and associated devices and methods for influencing the utilization of resources in a circumscribed venue. The exemplary system comprises an optimization server and one or more client devices configured as described herein.

In one embodiment, a computer-based optimization service executed by an optimization server transmits optimization data to client devices associated with participants of a circumscribed venue. The optimization service may identify one or more client devices that are associated with participants of the circumscribed venue. Venue participants may include the users, and other members of their parties, of one or more client devices whose client devices are currently positioned within the circumscribed venue.

In one embodiment, the optimization service utilizes one or more predefined listings of client devices associated with venue participants to associate client devices with venue participants, where such predefined listings are stored on data stores accessible to the optimization service. In another embodiment, the optimization service may receive one or more data transmissions from one or more client devices indicating that the client devices are within the circumscribed venue or that the client devices would like to participate in the optimization service. The data transmissions may utilize, for example, the SMS (Simple Message Service) or MMS (Multimedia Message Service) data transmission protocols. Responsive to receiving such data transmissions, the optimization service associates the client devices with venue participants. In yet another embodiment, the optimization service may be configured to associate client devices that are within the circumscription of the circumscribed venue with venue participants, as such client devices are logically operated by participants of the circumscribed venue. The circumscribed venue may be circumscribed, or constrained, by physical constraints, virtual constraints, economic constraints, and combinations thereof. Consequently, examples of circumscribed venues may include amusement parks, zoos, sporting arenas, convention centers, campuses, shopping malls, theatres, cruise ships, and airplanes. Furthermore, the optimization service may be executed to transmit one or more data transmissions to one or more client devices to confirm that the client devices are currently positioned within the circumscribed venue and wish to participate in the optimization service before the optimization service associates the client devices with venue participants.

Similarly, the optimization service may further identify one or more resources that are associated with venue resources. Resources may include, for example, restaurants, shops, shows, rides, and other venues offering goods or services to consumers. Venue resources are resources that are owned, operated, controlled, or otherwise associated with the circumscribed venue. In one embodiment, the optimization service utilizes one or more predefined listings of one or more resources that are associated with venue resources to associate resources with venue resources, where the listings are stored on one or more data stores accessible to the optimization service. In another embodiment, the optimization service may receive one or more data transmissions, from one or more resource-specific services executed on one or more resource-specific servers of one or more resources, indicating that the resources are within the circumscribed venue or that the resources wish to participate in the optimization service. The data transmissions may utilize, for example, the SMS or MMS data transmission protocols. Responsive to receiving such data transmissions, the optimization service may associate the resources with venue resources. In yet another embodiment, the optimization service may associate one or more resources whose current position is within the circumscription of the circumscribed venue with venue resources. Moreover, the optimization service may be executed to transmit one or more data transmissions to one or more resource-specific services to confirm that the resources are currently positioned within the circumscribed venue and wish to participate in the optimization service before the optimization service associates the resources with venue resources.

In another embodiment, the optimization service may disassociate client devices that were previously associated with venue participants. More specifically, once the users of client devices leave the circumscribed venue the client devices are no longer operated by participants of the circumscribed venue, and, consequently, the client devices should be disassociated with venue participants. In one embodiment, the optimization service utilizes one or more predefined listings of client devices that are no longer associated with venue participants to disassociate the client devices, where such predefined listings are stored on data stores accessible to the optimization service. In another embodiment, the optimization service may receive one or more data transmissions from client devices indicating that the client devices are no longer within the circumscribed venue or that the client devices no longer wish to participate in the optimization service. The data transmissions may utilize, for example, the SMS or MMS data transmission protocols. Responsive to receiving such data transmissions, the optimization service may disassociate the client devices. In yet another embodiment, the optimization service identifies one or more client devices that are no longer within the circumscribed venue by comparing the current position of the client devices to the circumscription of the circumscribed venue. Furthermore, the optimization service may transmit one or more data transmissions to one or more client devices to confirm that their users are no longer within the circumscribed venue and no longer wish to participate in the optimization service before the optimization service disassociates the client devices. Responsive to receiving such data transmissions, the optimization service may disassociate the client devices.

Likewise, the optimization service may disassociate resources that were previously associated with venue resources. For example, a food cart or other mobile resource may be removed from the circumscribed venue for reasons such as weather, seasonal attraction, or underperformance. In one embodiment, the optimization service utilizes one or more predefined listings of resources that are no longer associated with venue resources to disassociate the resources, where such predefined listings are stored on data stores accessible to the optimization service. In another embodiment, the optimization service may receive one or more data transmissions from venue-specific services executed on venue-specific servers indicating that the resources are no longer within the circumscribed venue or that the resources no longer wish to participate in the optimization service. The data transmissions may utilize, for example, the SMS or MMS data transmission protocols. Responsive to receiving such data transmissions, the optimization service may disassociate the resources. In yet another embodiment, the optimization service identifies one or more resources that are no longer within the circumscribed venue by comparing the current position of the resources with the circumscription of the circumscribed venue. Moreover, the optimization service may transmit one or more data transmissions to one or more resource-specific servers associated with the resources to confirm that the resources are no longer within the circumscribed venue and no longer wish to participate in the optimization service before the optimization service disassociates the resources. Responsive to receiving data transmissions indicating that the resources are confirmed to be outside of the circumscribed venue, the optimization service may disassociate the resources.

Upon identifying the venue resources and venue participants, the optimization service determines the optimal utilization of such venue resources. The optimal utilization may comprise a listing of preferred utilization rates for each of the venue resources. Alternatively, the optimization service may utilize one or more optimization algorithms now known or later developed to determine the optimal utilization of the venue resources. The optimization service may configure the optimization algorithm to base the optimal utilization determination at least in part on one or more venue-specific factors and participant-specific factors; for instance, the optimization algorithm may take into account the inventory status of the venue resources, the capacity of the venue resources, the utilization of the venue resources, the positional relationship between the venue resources and the client devices, one or more venue preferences, and one or more participant preferences.

The venue preferences may comprise considerations affecting the operations of the circumscribed venue such as business considerations, legal considerations, economic considerations, and combinations thereof. For instance, the venue preferences may indicate the advertising history of the venue resources, the maintenance history of the venue resources, and the historical sales records of venue participants and venue resources, respectively. The participant preferences may comprise factors affecting the experience of the venue participant such as the venue participant's and other members of the venue participant's parties' age, gender, bodily traits, preferred resource types, preferred venue resources, and combinations thereof. For example, the participant preferences may indicate which venue participants are minors, the ratio of male venue participants to female venue participants, the height of venue participants, which venue participants prefer to access rock concerts, and which venue participants prefer to access the circumscribed venue's Ferris wheel, respectively.

Once the optimization service has determined the optimal utilization of the venue resources, the optimization service transmits optimization data to the client devices associated with the venue participants. In one embodiment, the optimization service is configured to establish a secure connection with the client devices over which to transmit the optimization data to the client devices. For instance, the code may be configured to utilize Hypertext Transfer Protocol Secure (HTTPS), a Virtual Personal Network (VPN) connection, or another now know or later developed secure transport protocol. The optimization service may be further configured to only transmit optimization data to client devices utilizing a secure container in which the associated venue participants may access the optimization data, as described in application Ser. No. 13/396,356 entitled “CONTROLLING DISTRIBUTION OF RESOURCES IN A NETWORK,” which is incorporated herein by reference. In another embodiment, the code is configured to transmit the incentives to a web-based service that the client device has authorization to access. In yet a further embodiment, the code is configured to transmit the incentives to the client devices directly without enabling any security protocols, measures, or applications. For example, the code may be configured to transmit the incentives to the client devices utilizing either the SMS or MMS data transmission protocols.

The optimization service determines which optimization data to transmit to venue participants based at least in part on the optimal utilization of the venue resources. For example, optimization data, such as a coupon, for a venue resource with particularly low utilization may be generated based on the optimal utilization determination indicating that the venue resource is under-utilized. The optimization data may comprise one or more of an indication of a venue resource, an indication of a venue resource's traits, an access requirement associated with a venue resource, an incentive associated with a venue resource, a directive associated with an incentive, and combinations thereof. The optimization data may be associated with a single venue resource or multiple venue resources; for instance, both indications of a single venue resource and indications of multiple venue resources may constitute optimization data. An indication of a venue resource may comprise the name of the associated venue resource or another unique identifier associated with the venue resource. An indication of a venue resource's traits may comprise one or more of real-time queue wait data, delayed queue wait time data, direction data, current position data, map data, traffic data, coupon data, advertising data, emergency message data, or any other data describing the venue resources. Map data may comprise one or more of graphical indications of the current position of venue resources in relation to the current position of client devices, the current position of venue resources in relation to the circumscription of the circumscribed venue, the current position of client devices in relation to the circumscription of the circumscribed venue, and combinations thereof. Alternatively, map data may comprise one or more graphical indications of the positions of venue resources and client devices over a period of time.

The optimization data may further include metadata that describes and/or regulates the use of the optimization data. For example, optimization data may include metadata indicating categories/sub-categories to which the optimization data belongs, favorite-status, ownership, issuer, confidentiality status, access restriction status, password protection status, history, description, comments, size and format, download priority, expiration date, and effective dates. The optimization data may be configured in one or more of basic text files, word processor files, pdf or similar protected files, picture files, video files, web-based files, link files, executable application files, any other file type now known or later developed, and combinations thereof.

In one embodiment, the optimization service is only executed upon receiving one or more data communications from one or more client devices associated with one or more venue participants. More specifically, the data communication may comprise an indication of the current position of the client device, a transmission of the device profile of the client device, a client device request for a distribution of optimization data, a client device request to register with the optimization service, and combinations thereof. Alternatively, the optimization service is executed notwithstanding the reception of one or more data communications from client devices associated with venue participants.

In another embodiment, a computer-based method is executed by client devices associated with participants of a circumscribed venue. First, one or more client devices transmit one or more data communications to a computer-based optimization service. Next, the client devices receive optimization data from the optimization service. Then, the client devices render the optimization data on the client devices for the venue participants associated with such client devices. More specifically, the client devices may render the optimization data by providing access to such data for the associated venue participant through one or more user interfaces that are executed on the client device. Additionally, the client devices may further render the optimization data by displaying one or more characters that are commercially associated with the circumscribed venue on the user interfaces.

In yet another embodiment, a non-transitory computer-readable medium executed by a computing device transmits one or more incentives, based at least in part on the inventory status of one or more venue resources, to one or more client devices associated with one or more venue participants. The medium comprises code configured to determine the status of the inventory of one or more resources of the circumscribed venue. The inventory of the venue resources may comprise one or more units of physical product, virtual product, theoretical product, and combinations thereof as can be appreciated. The code may determine the inventory status by interfacing with a venue resource-specific service executed by a venue resource-specific server to obtain the inventory status. In one embodiment, the code may be configured to obtain the inventory status from such venue resource-specific service on a continuous basis in real-time. Alternatively, the code may be configured to obtain the inventory status on a periodic basis to reduce the burden on network operations. The inventory status may comprise at least one or more of indications of the associated venue resource's total storage capacity, total storage utilization, quantities of inventory stored, types of inventory stored, and traits of inventory stored. The inventory types may comprise at least one or more of raw material inventory, WIP (work-in-process) inventory, finished good inventory, merchandise inventory, manufacturing inventory, purchased inventory, consumable inventory, transit inventory, buffer inventory, anticipatory inventory, decoupling inventory, cycle inventory, MRO (maintenance, repair, and operating) inventory, and theoretical inventory. The inventory traits may comprise at least one or more of indications of the venue resource's inventory's current position, ownership, availability, expiration dates, effective dates, handling requirements and storage requirements.

The medium further comprises code that identifies one or more incentives based at least in part on the inventory status of the venue resources. The code may be configured to obtain a listing of one or more incentives predetermined to be associated with the inventory statuses. Alternatively, the code may determine which incentives to associate with the inventory statuses based at least in part on one or more venue-specific factors and participant-specific factors, such as the inventory status of the venue resources, the capacity of the venue resources, the utilization of the venue resources, the positional relationship between the venue resources and the client devices, the venue preferences, and the participant preferences.

In one embodiment, the incentives comprise access-based advantages associated with the venue resources. For instance, the incentives may authorize the venue participant associated with the client device with the incentive to skip ahead of those venue participants without the incentive in the queue for access to a venue resource. In another embodiment, the incentives may comprise economic-based advantages associated with the venue resources. The economic incentive, such as a coupon, may provide access to a specific venue resource at a lower cost than the amount that venue participants without the incentive are required to pay to access the venue resource. The use of inventory status-based incentives may be advantageous to the operations of a circumscribed venue by influencing venue participants to access, for instance, expiring inventory at a distant venue resource rather than the effective inventory of a venue resource that is closer to the current position of their client devices. More specifically, a venue participant may be influenced to travel a further distance to access expiring inventory of a venue resource upon receiving an incentive authorizing the venue participant to obtain the inventory at a lower cost; accordingly, the use of the incentive benefits the circumscribed venue by reducing costs related to expired inventory and benefits venue participants by reducing costs related to accessing the inventory of venue resources.

Furthermore, the medium comprises code that transmits the incentives to one or more client devices associated with one or more venue participants. As previously disclosed with regard to the optimization service, the code may be configured to associate and disassociate client deices with venue participants based on one or more of utilizing predefined listings of client devices, by receiving data transmissions from client devices, determining whether the client devices' current position is within the circumscribed venue, and transmitting data transmissions to confirm that client devices should or should not be associated with venue participants. And, as previously disclosed with regard to an optimization service executed by an optimization server, the code may be configured to utilize or not to utilize one or more security protocols, measures, and applications to transmit the incentives to the client devices associated with venue participants.

In another embodiment, the medium comprises code further configured to only transmit one or more incentives to one or more client devices that have satisfied one or more directives associated with the incentives. The code may be configured to first identify one or more directives that are associated with the incentives. In particular, the code may be configured to obtain a listing of one or more directives predefined to be associated with one or more incentives. Alternatively, the code may determine which directives to associate with the incentives based at least in part on one or more venue-specific factors and participant-specific factors, such as the inventory status of the venue resources, the capacity of the venue resources, the utilization of the venue resources, the positional relationship between the venue resources and the client devices, the venue preferences, and the participant preferences.

The directives may comprise one or more requirements that must be satisfied by venue participants to obtain authorization to receive one or more incentives on the respective client devices. The directives may also be based at least in part on one or more of the inventory status of the venue resources, the capacity of venue resources, the utilization of venue resources, the positional relationship between the venue resources and the client devices, one or more venue preferences, one or more participant preferences, and combinations thereof. The code may be configured to transmit the directives to one or more client devices associated with venue participants. Responsive to a determination that the directives are satisfied by the recipient client devices, the code is configured to transmit one or more incentives to the recipient client devices.

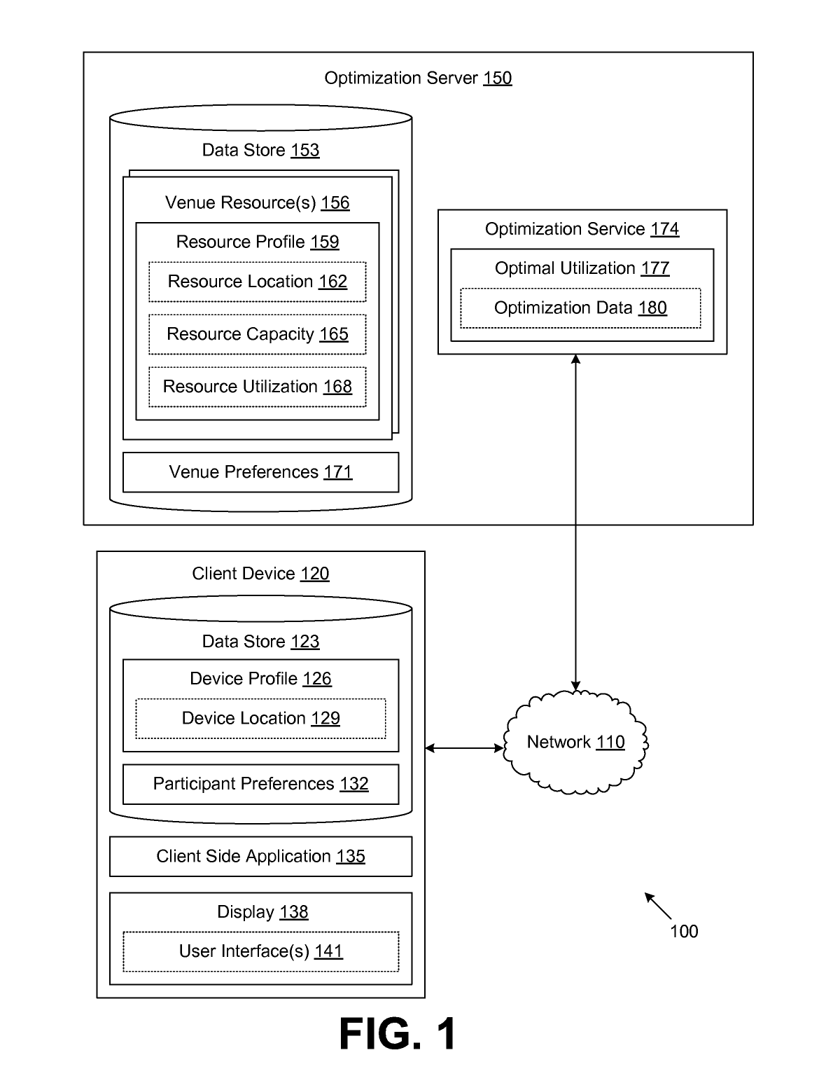

FIG. 1 illustrates a networked environment 100 according to various embodiments. The networked environment 100 includes a network 110, a client device 120, and an optimization server 150. The network 110 may be or include, for example, any type of wireless network such as a wireless local area network (WLAN), a wireless wide area network (WWAN), or any other type of wireless network now known or later developed. More specifically, the network 110 may be or include WWANs such as CDMA, TDMA, 3G, 4G, LTE, PCS, iDEN, or any other WWAN now know or future developed. Additionally, the network 110 may be or include the Internet, intranets, extranets, microwave networks, satellite communications, cellular systems, PCS, infrared communications, global area networks, or other suitable networks, etc., or any combination of two or more such networks. In one embodiment, the network 110 facilitates transmission of optimization data 180 between one or more client devices 120 and the optimization server 150.

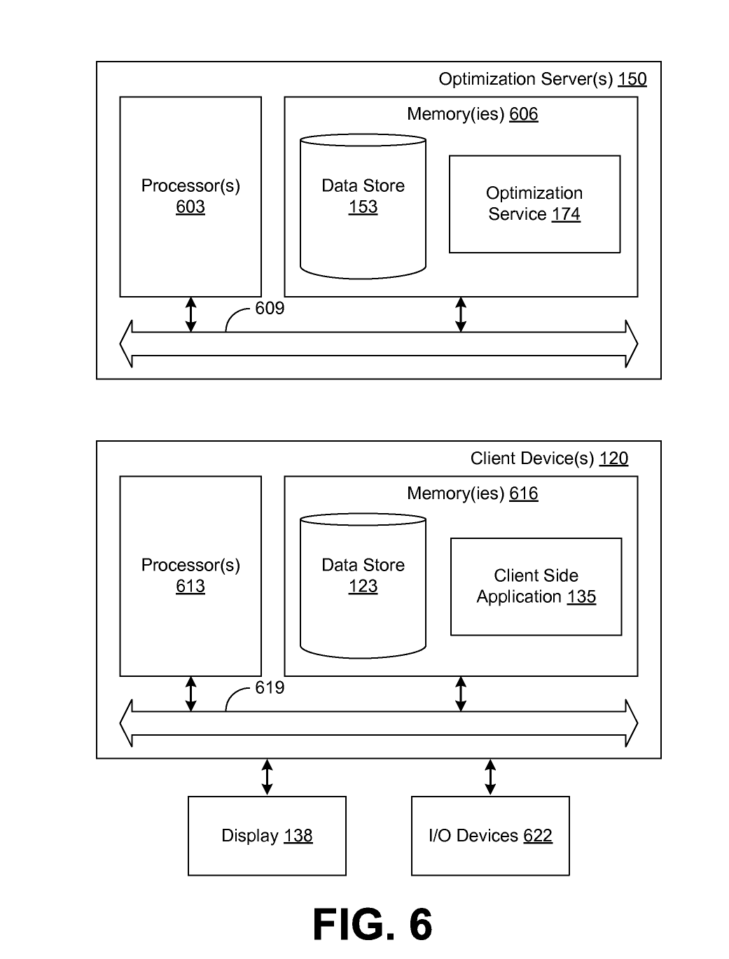

The client device 120 may be a desktop computer, a laptop computer, a personal digital assistant, a cellular telephone, a set-top box, a music player, a web pad, a tablet computer system, a game console, and/or another device with like capability. The client device 120 may include a wired network connectivity component (not shown in FIG. 1), for example, an Ethernet network adapter, a modem, and/or the like. The client device 120 may further include a wireless network connectivity interface (not shown in FIG. 1), for example, a PCI (Peripheral Component Interconnect) card, USB (Universal Serial Bus) interface, PCMCIA (Personal Computer Memory Card International Association) card, SDIO (Secure Digital Input-Output) card, NewCard, Cardbus, a modem, a wireless radio transceiver, and/or the like. The client device 120 is operable to communicate via wired connection with the optimization server 150 with the aid of the wireless network connectivity component. The client device 120 may further comprise a memory for storing data and applications, a processor for executing applications stored in memory, and a local interface such as a bus, as will be described with respect to FIG. 6.

The client device 120 may store in a data store 123 a device profile 126 and one or more participant preferences 132. In one embodiment, the device profile 126 may comprise an indication of the current position of the associated client device, referred to herein as the device location 129. The device profile 126 may further comprise indications of the hardware, software, and security attributes which describe the client device 120. For instance, the device profile 126 may represent hardware specifications of the client device 120, version and configuration information of various software program and hardware components installed on the client device 120, data transmission protocols enabled on the client device 120, version and usage information of various resources stored on the client device 120, and/or any other attributes associated with the state of the client device 120. The device profile 126 may yet further include data indicating a date of last virus scan of the client device 120, a date of last access by an IT representative, a date of a last access by the optimization server 150, a date of last service by the IT representative, and/or any other data indicating maintenance and usage of the client device 120. Furthermore, the device profile 126 may comprise indications of the past behavior of the associated venue participant, such as which venue resources have been accessed, the amount paid to access the venue resources, and the inventory accessed from venue resources. The participant preferences 132 may comprise a listing of factors that may affect the experience of the venue participants. In particular, participant preferences 132 may include indications of the venue participant's and other members of the venue participant's parties' age, gender, bodily traits, preferred resource types, preferred venue resources, and combinations thereof.

The client device 120 may be configured to execute various applications. For example, the client device 120 may be configured to execute applications such as web browsing applications, email applications, instant messaging applications, and/or other applications capable of receiving and/or rendering optimization data 180 on a display 138 associated with the client device 120. Any applications capable of receiving and/or rendering optimization data on a display 138 is generally referred to herein as a “client side application” 135. The client side application 135 may be stored in the memory 616 (FIG. 6) of the client device 120. In one embodiment, the client side application 135 may be a browser program configured to receive and render the optimization data 180. In another embodiment, the client side application 135 may be a secure container program that may be executed to receive and render the optimization data 180 in a secure environment, as described in application Ser. No. 13/396,356 entitled “CONTROLLING DISTRIBUTION OF RESOURCES IN A NETWORK.”

In particular, the client side application 135 may be configured to optionally restrict access to the optimization data 180 by other applications executed by the client device 120, thus preventing access to the optimization data 180 by an application other than the client side application 135. In one embodiment, the client side application 135 may monitor network traffic between the client device 120 and the optimization server 150 and identify any data being transmitted between an application executed by the client device 120 other than the client side application 135 and the optimization server 150. The client side application 135 may then determine whether an instance of optimization data 180 is being provided to an application other than the client side application 135 executed by the client device 120 and intercept and/or block the incoming instance of optimization data 180. In another embodiment, the client side application 135 may allow an intercepted instance of optimization data 180 to be accessible to the venue participant associated with a client device 120 through a user interface 141 rendered by the client side application 135. The client side application 135 may further deny access to any other application on the client device 120 attempting to access the intercepted instance of optimization data 180. In yet another embodiment, the client side application 135 may be executed to call on other services associated with the optimization data 180 that are executed on the optimization server 150 or another server or device accessible to the client side application 135. For instance, the client side application may call on a technical support service that is also executed on the optimization server 150.

The client side application 135 may be executed to render optimization data 180 on the client device 120 for the associated venue participant. The client side application 135 may be configured to render the optimization data 180 in accordance with the metadata associated with the optimization data 180. For example, the client side application 135 may determine not to render optimization data 180 that has metadata indicating that the optimization data 180 is expired. The client side application 135 may be further configured to render the optimization data 180 in accordance with the device profile 126 of the associated client device 120. For instance, the client side application 135 may determine not to render optimization data 180 if the device profile 123 indicates that the client device has not been recently serviced by IT.

Additionally, the client side application 135 may be configured to execute one or more user interfaces 141 on the display 138 of the client device 120 to provide access to the optimization data 180 for the associated venue participant. In particular, the optimization data 180 may be rendered on a user interface 141 by decompressing compressed files and presenting the uncompressed files, mounting disk image files and presenting the mounted image files, running executable files and presenting the executed files, by enabling a data search of the optimization data 180 and presenting the featured output in a user interface, by calling on another application on the client device 120 to respond to data links contained within the optimization data 180, and/or by transmitting a part or the whole of the optimization data 180 to another application on the client device 120. The client side application 135 may be executed to present a single instance of optimization data 180 or a series of instances of optimization data 180 in a comprehensive manner, for instance, presenting several instances of optimization data 180 in a slideshow presentation. Similarly, the client side application 135 may be executed to render an environment that presents an array of instances of optimization data 180 in a single view, such as a category-based tree or outline format.

Moreover, the client side application 135 may be executed to transmit a request for optimization data 180 to the optimization service 174. For example, the client side application 135 may be executed to transmit such requests utilizing the SMS data transmission protocol, MMS data transmission protocol, or another now know or later developed data transmission protocol. The client side application 135 may be configured to only render optimization data 180 associated with a request for optimization data previously transmitted by the client side application 135 to the optimization service 174. Alternatively, the client side application 135 may be configured to only render optimization data 180 while the client device 120 is in communication with the optimization service 174.

The optimization server 150 may comprise, for example, a computer-based server or any other system providing optimization capabilities. Alternatively, one or more optimization servers 150 may be employed that are arranged, for example, in one or more server banks or computer banks or other arrangements. For example, one or more optimization servers 150 together may comprise a cloud computing resource, a grid computing resource, and/or any other distributed computing arrangement. Such optimization servers 150 may be located in a single installation or may be distributed among many different geographic locations. For purposes of convenience, the optimization server 150 is referred to herein in the singular. Although the optimization server 150 is referred to in the singular, it is understood that a one or more optimization servers 150 may be employed in the arrangements as described herein.

The optimization server 150 comprises a data store 153, an optimization service 174, and other applications, services, processes, systems, engines, or functionality not disclosed in detail herein. The data store 153 may be configured to store data related to venue resources 156 including associated resource profiles 159 detailing one or more of the resource location 162, resource capacity 165, and resource utilization 168. The data store 153 may further store one or more venue preferences 171, which may comprise one or more considerations that affect the operations of the circumscribed venue; for example, venue preferences may include business considerations, legal considerations and economic considerations.

Furthermore, the data store 153 may store optimization data 180. For purposes of convenience, the optimization data 180 is shown in FIG. 1 as located within the optimization service 174; it is understood that the optimization data 180 may be stored in the data store 153, locally within the optimization service 174, or on any other storage medium accessible to the optimization service 174. In one embodiment, the optimization data 180 comprises at least one or more of an indication of a venue resource 156, an indication of the traits of a venue resource 156, an access requirement associated with a venue resource 156, an incentive associated with a venue resource 156, a directive associated with an incentive, and combinations thereof. In another embodiment, the optimization data 180 may further comprise metadata that describes and/or regulates the use of the optimization data 180. In particular, the optimization data 180 may include metadata indicating categories and/or subcategories, “favorite” status, ownership, confidentiality, access restrictions, password protection, history, comments, size and/or format, download priority, expiration dates, and effective dates associated with the optimization data 180.

The data store 153 may be representative of one or more data stores, as can be appreciated. The data stored in the data store 153, for example, is associated with the operation of the applications and/or functional entities described herein. The data store 153 may utilize strong encryption standards to protect the data stored within from unauthorized access. For instance, the data store 153 may utilize SHA-1 (Standard Hash Algorithm) or a similar strong encryption standard commonly utilized for server-side data storage.

The optimization service 174 is configured to determine the optimal utilization 177 of the venue resources 156. In one embodiment, the optimal utilization 177 may comprise a listing of the preferred, or optimal, ratio of the utilization of each venue resource 156 to the capacity of each venue resource 156, which may be stored in the data store 153 or another data store accessible to the optimization service 174. In determining the optimal utilization 177 of the venue resources 156, the optimization service 174 determines which resources to associate with resources of the circumscribed venue and which client devices 120 to associate with participants of the circumscribed venue.

In one embodiment, the optimization service 174 utilizes a predefined listing of one or more resources associated with venue resources 156 and one or more client devices 120 associated with venue participants, which may be stored in the data store 153 or another data store accessible to the optimization service 174. In another embodiment, the optimization service 174 may identify one or more client devices 120 and one or more resource-specific services executed on one or more resource-specific servers of one or more resources that have transmitted one or more data communications to the optimization service 174 and associate them with venue participants and venue resources, respectively. The data communications may comprise one or more of an indication of the current position of the client device 120, a transmission of the device profile 126 of the client device 120, a client device request for a distribution of optimization data 180, a client device request to register with the optimization service 174, another now known or future developed data communication, and combinations thereof.

In yet another embodiment, the optimization service 174 identifies one or more client devices 120 and one or more resources that are within the circumscribed venue. The optimization service 174 may be configured to associate client devices 120 and resources whose current positions are within the circumscribed venue with venue participants and venue resources, respectively. In particular, the circumscribed venue may be circumscribed, or constrained, by physical constraints, virtual constraints, economic constraints, and combinations thereof.

On the contrary, the optimization service 174 may disassociate client devices 120 previously associated with venue participants and resources previously associated with venue resources if the respective client devices 120 and resources are no longer within the circumscribed venue. In one embodiment, the optimization service 174 utilizes a predefined listing of one or more resources no longer associated with venue resources 156 and one or more client devices 120 no longer associated with venue participants, which may be stored in the data store 153 of the optimization service 174. In another embodiment, the optimization service 174 may identify one or more client devices 120 and one or more resource-specific services that have transmitted one or more data communications to the optimization service 174 that indicate that the respective client devices and resources are no longer associated with the circumscribed venue. Responsive to receiving such data transmissions, the optimization service 174 may disassociate the client devices and resources. In yet another embodiment, the optimization service 174 identifies one or more client devices 120 previously associated with venue participants and one or more resources previously associated with venue resources 156 whose current positions are no longer within the circumscribed venue and dissociates the respective client devices and resources.

Additionally, the optimization service 174 may transmit one or more data transmissions to one or more client devices and one or more resources to confirm whether the client devices and resources are associated with the circumscribed venue. The optimization service 174 may, for instance, utilize the SMS or MMS data transmission protocols to query the client devices and resources. Response to receiving one or more responsive data transmissions indicating that one or more client devices or one or more resources not previously associated with the circumscribed venue are either within the circumscribed venue or wish to participate in the optimization service 174, the optimization service 174 may associate the client devices and resources with venue participants and venue resources, respectively. On the contrary, response to receiving one or more responsive data transmissions indicating that one or more client devices or one or more resources previously associated with the circumscribed venue are either no longer within the circumscribed venue or no longer wish to participate in the optimization service, the optimization service 174 may disassociate the client devices and resources. The optimization service 174 may be further executed to store the resultant listing of client devices 120 associated with venue participants and resources associated with the venue resources 156 on the data store 153, which may be utilized by the optimization service 174 for future operations.

In one embodiment, the optimization service 174 determines the optimal utilization 177 of the venue resources 156 by accessing one or more predefined listings stored on the data store 153 or another data store accessible to the optimization service 174. In another embodiment, the optimization service 174 determines the optimal utilization 177 of the venue resources 156 by executing one or more optimization algorithms now known or later developed. More specifically, an optimization algorithm comprises one or more algebraic expressions formulated to maximize the resource utilization 168 of one or more venue resources 156 while taking into account one or more venue-specific and participant-specific variables. The optimization service 174 may be executed to determine the optimal utilization 177 based at least in part on the inventory status of the venue resources 156, the resource capacity 165 of the venue resources 156, the resource utilization 168 of the venue resources 156, the positional relationship between the venue resources 156 and the client device 120, one or more venue preferences 171, one or more participant preferences 132, and combinations thereof.

The resource capacity 165 may comprise an indication of the number of venue participants that a given venue resource 156 can potentially serve at the current time. For example, a venue resource 156 with a small dining area may only accommodate a maximum of ten venue participants, whereas a venue resource 156 with a large dining area may accommodate a maximum of fifty venue participants. Additionally, a given venue resource 156 may only serve venue participants outdoors and, as a result, may have a capacity of greater than zero when the weather is good and a capacity of zero when the weather is poor. In one embodiment, the resource capacity 165 may comprise one or more predefined values that are stored on the data store 153. Alternatively, the optimization service 174 may request the resource capacity 165 from another computer-based service accessible to the optimization service 174; for example, the resource capacity 165 may be obtained from a venue resource-specific service executed on a venue resource-specific server associated with an individual venue resource 156. Upon receiving the resource capacity 165 from an external service, the optimization service 174 may be executed to store the resource capacity 165 in the data store 153 for future operations.

The resource utilization 168 may comprise an indication of the number of venue participants that a given venue resource 156 is actually serving at the current time. In one embodiment, the resource utilization 168 may be a predefined value that is stored on the data store 153. Alternatively, the optimization service 174 requests the resource utilization 168 from another accessible computer-based service, such as a venue resource-specific service executed on a venue resource-specific server of an individual venue resource 156. Upon receiving the resource utilization 168 from an external service, the optimization service 174 may be executed to store the resource utilization 168 in the data store 153 for future operations.

The optimization service 174 may determine the positional relationship between the venue resources 156 and client device 120 by comparing the resource location 162 and the device location 129. The resource location 162, associated with the resource profile 159 of a venue resource 156, may comprise one or more coordinates capable of being utilized by a global positioning system (GPS) or another positioning system now known or later developed. In one embodiment, the resource location 162 is a predetermined set of coordinates stored on the data store 153. In another embodiment, the optimization service 147 obtains the resource location 162 from an external service accessible to the optimization service 147, such as a venue resource-specific service executed on a venue resource-specific server of an individual venue resource 156.

The device location 129, associated with the device profile 126 of the client device 120, may also comprise one or more positional coordinates, as described with respect to the resource location 162. The optimization service 174 may obtain the device location 129 from a client device 120 by transmitting a request for the device location 129 to the client side application 135 of the client device 120. Responsive to receiving a request for the device location 129 of the client device 120, the client device 120 may be configured to execute the client side application 135 to transmit the device location 129 to the optimization service 174. In one embodiment, the client side application 135 obtains the device location 129 from the device profile 126 of the client device 120. In another embodiment, the client side application 135 determines the device location 129 by interfacing with a GPS or similar positioning system. The client side application 135 may be further executed to transmit the device location 129 to the optimization service 174, for instance, by utilizing the HTTPS, VPN, SMS, MMS, or another now known or later developed data transmission protocol.

The optimization service 174 may be further executed to transmit optimization data 180 to one or more client devices 120. In one embodiment, the optimization service 174 may determine which optimization data 180 to transmit to the client devices 120 based at least in part on the optimal utilization 177. In particular, the optimization service 174 may parse the optimal utilization 177 with the optimization data 180 by matching data based on the associated venue resources 156. As a result, the optimization service 174 may prioritize the distribution of optimization data 180 to the client devices 120 based on the varying optimal utilization 177 of the venue resources 156. Additionally, the optimization service 174 may base the determination on the metadata associated with the optimization data 180. For instance, the optimization service 174 may be configured to distribute optimization data 180 with a lower priority, based on the optimal utilization 177, if the optimization data 180 with a higher priority is associated with metadata indicating that the optimization data 180 with the higher priority has expired. Furthermore, the optimization service 174 may base the determination on the device profile 126 of the client device 120; the optimization service 174 may, for example, be configured to only transmit optimization data 180 with confidentiality restrictions to client devices 120 with enabled security settings.

Upon determining the optimization data 180, the optimization service 174 may be configured to transmit the optimization data 180 to the client devices 120. As previously disclosed, the optimization service 174 may be configured to utilize one or more security protocols, measures, and applications to transmit the optimization data 180 to client devices 120, such as HTTPS, VPN, secure containers as described in application Ser. No. 13/396,356 entitled “CONTROLLING DISTRIBUTION OF RESOURCES IN A NETWORK,” and secure web-based access. Alternatively, the optimization service 174 may be configured to transmit the optimization data 180 without enabling any such security protocols, measures, and applications. For example, the optimization service 174 may be configured to transmit the optimization data 180 to client devices 120 utilizing either the SMS or MMS data transmission protocols.

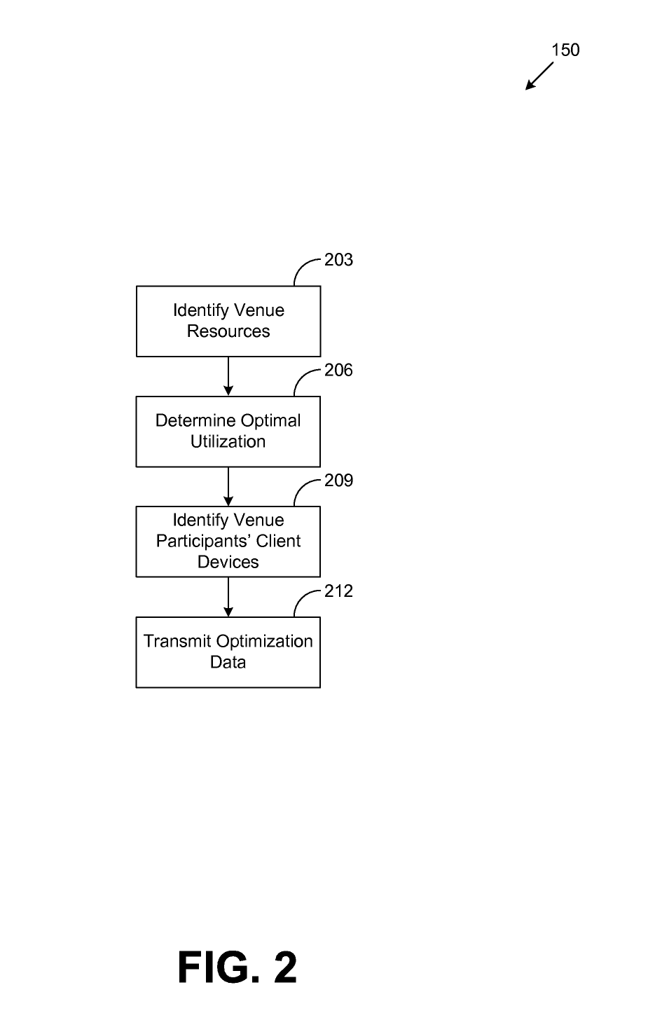

FIG. 2 is a flowchart illustrating exemplary functionality performed by the optimization service 174 (FIG. 1) according to certain embodiments. It is understood that the flowchart of FIG. 2 provides merely an example of the many different types of functional arrangements that may be employed to implement the operation of the optimization service 174 as described herein. As an alternative, the flowchart of FIG. 2 may be viewed as depicting an example of steps of a method implemented in the optimization server 150 (FIG. 1) according to one or more embodiments. It is further understood that steps of the present disclosure could be added, removed, altered, combined, and reordered without departing from the spirit and the scope of the present disclosure.

Beginning with step 203, the optimization service 174 identifies which resources are associated with the circumscribed venue. As disclosed with regard to FIG. 1, the optimization service 174 may be executed to associate and disassociate resources with venue resources 156 (FIG. 1) based on predefined listings, data transmissions, and the current positional relationship between the resources and the circumscribed venue. Furthermore, the optimization service 174 may utilize data transmissions to confirm that resources should be associated or disassociated with venue resources 156.

Then, in step 206, the optimization service 174 determines the optimal utilization 177 (FIG. 1) of the venue resources 156. As disclosed with regard to FIG. 1, in one embodiment, the optimization service 174 may be executed to determine the optimal utilization 177 based on one or more predefined listings stored on the data store 153 (FIG. 1) or another data store accessible to the optimization service 174. In another embodiment, the optimization service 174 executes one or more optimization algorithms configured to base the optimal utilization 177 determination on one or more venue-specific and participant-specific variables.

Next, in step 209, the optimization service 174 identifies which client devices 120 (FIG. 1) are associated with venue participants. As disclosed with regard to FIG. 1, the optimization service 174 may be executed to associate and disassociate client devices 120 with venue participants based on predefined listings, data transmissions, and the current positional relationship between the client devices 120 and the circumscribed venue. Furthermore, the optimization service 174 may utilize data transmissions to confirm that client devices 120 should be associated or disassociated with venue participants.

Additionally, in step 212, the optimization service 174 transmits optimization data 180 (FIG. 1) to the client devices 120 associated with venue participants. As disclosed with regard to FIG. 1, the optimization service 174 may be executed to determine which optimization data 180 to transmit to client devices 120 based on one or more of the optimal utilization 177 of the venue resources 126, metadata associated with the optimization data 180, and the device profile 126 (FIG. 1.) of the client devices 120. In one embodiment, the optimization service 174 may be configured to transmit the optimization data 180 to the client devices 120 by utilizing one or more security protocols, measures, and applications, such as HTTPS, VPN, secure containers, and secure web-based access. In another embodiment, the optimization service 174 may be configured to transmit the optimization data 180 without enabling security protocols, measures, or applications, such as by utilizing SMS or MMS data transmission protocols.

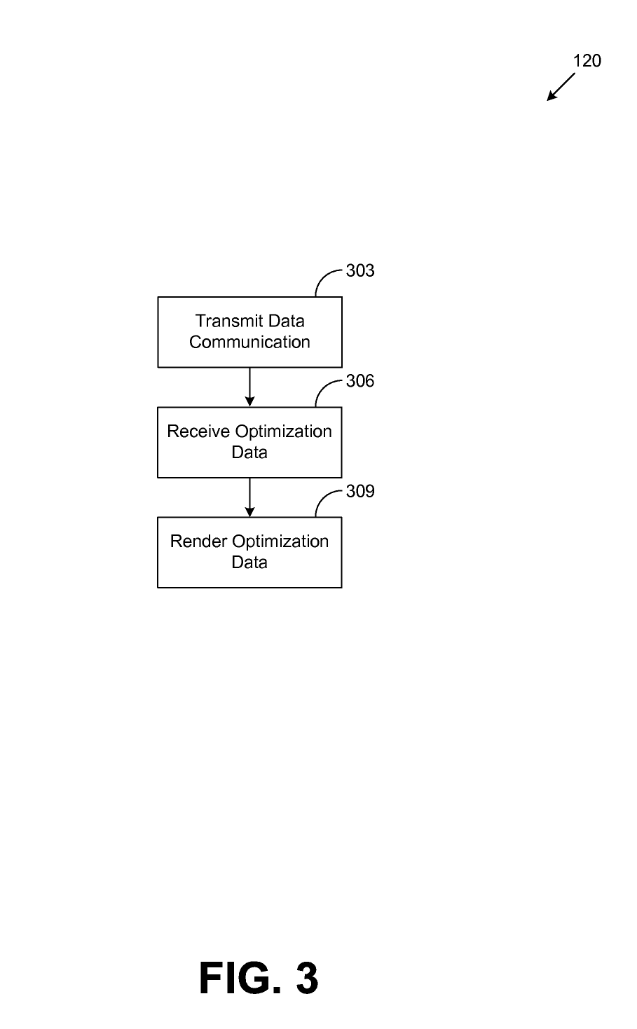

FIG. 3 is a flowchart illustrating exemplary functionality performed by a client side application 135 (FIG. 1) executed on a client device 120 (FIG. 1) according to certain embodiments. It is understood that the flowchart of FIG. 3 provides merely an example of the many different types of functional arrangements that may be employed to implement the operation of the client side application 135 as described herein. As an alternative, the flowchart of FIG. 3 may be viewed as depicting an example of steps of a method implemented in the client device 120 according to one or more embodiments. It is further understood that steps of the present disclosure could be added, removed, altered, combined, and reordered without departing from the spirit and the scope of the present disclosure.

Beginning with step 303, the client side application 135 transmits one or more data communications to a computer-based service configured to optimize the utilization of resources in a circumscribed venue, such as the optimization service 174 (FIG. 1). The data communication may comprise one or more of an indication of the current position of the client device 120, a transmission of the device profile 126 (FIG. 1) of the client device 120, a client device 120 request for a distribution of optimization data 180 (FIG. 1), a client device 120 request to register with the optimization service 174, another now known or later developed data communication, and combinations thereof. The client side application 135 determine the current position of the client device 120 by accessing the device location 129 (FIG. 1) of the device profile 126 stored on the data store 123 (FIG. 1). Alternatively, the client side application 135 may determine the current position of the client device 120 by interfacing with one or more GPS services. In one embodiment, the client side application 135 may be configured to transmit data communications to the optimization service 174 by utilizing one or more security protocols, measures, and applications, such as HTTPS, VPN, secure containers, and secure web-based access. In another embodiment, the client side application 135 may be configured to transmit data communications to the optimization service 174 without enabling security protocols, measures, or applications, such as by utilizing SMS or MMS data transmission protocols.

Next, in step 306, the client side application 135 receives a distribution of optimization data 180 from the optimization service 174. In one embodiment, the client side application 135 may be configured to establish a secure connection with the optimization service 174 and receives the optimization data 180 over the secure connection. The client side application 135 may be further configured to only receive optimization data 180 while enabling a secure container in which the venue participant may access the optimization data 180, as described in application Ser. No. 13/396,356 entitled “CONTROLLING DISTRIBUTION OF RESOURCES IN A NETWORK.” In another embodiment, the client side application 135 receives an indication from the optimization service 174 that the optimization data 180 has been transmitted to a web-based service. The client side application 135 may then receive a transmission of web-based service authentication credentials from the optimization service 174. Alternatively, the client side application 135 may obtain the authentication credentials required to access the optimization data 180 stored on the web-based service from the data store 123 (FIG. 1) of the client device 120 or another data store accessible to the client side application 135. In yet another embodiment, the client side application 135 receives the optimization data 180 from the optimization service 174 directly without enabling any security protocols, measures, or applications. For example, the client devices 120 may be configured to receive the optimization data 180 utilizing either the SMS or MMS data transmission protocols.

Then, in step 309, the client side application 135 renders the optimization data 180 on the client device 120. The client side application 135 may execute one or more user interfaces 141 (FIG. 1) on the display 138 (FIG. 1) of the client device 120 on which to render the optimization data 180. The user interfaces may be executed within a secure container as described in application Ser. No. 13/396,356 entitled “CONTROLLING DISTRIBUTION OF RESOURCES IN A NETWORK.” Additionally, the client side application 135 may display the optimization data 180 on the user interfaces 141 in conjunction with one or more depictions of characters commercially associated with the circumscribed venue. For example, the client side application 135 may present optimization data 180, such as a coupon for lunch at a restaurant that is commercially associated at least in part with a depiction of an animated mouse, in conjunction with such animated mouse.

In another embodiment, the client side application 135 may determine how to render the optimization data 180 based at least in part on the metadata associated with the optimization data 180. For instance, the client side application 135 may determine that it is not authorized to render optimization data 180 with metadata indicating that the optimization data 180 is expired. Similarly, the client side application 135 may determine how to render the optimization data 180 based at least in part on the device profile 126 (FIG. 1) of the client device 120. The client side application 135 may, for example, determine that a client device 120 does not satisfy the security requirements for rendering the optimization data 180 based on metadata indicating that the optimization data 180 is confidential in nature.

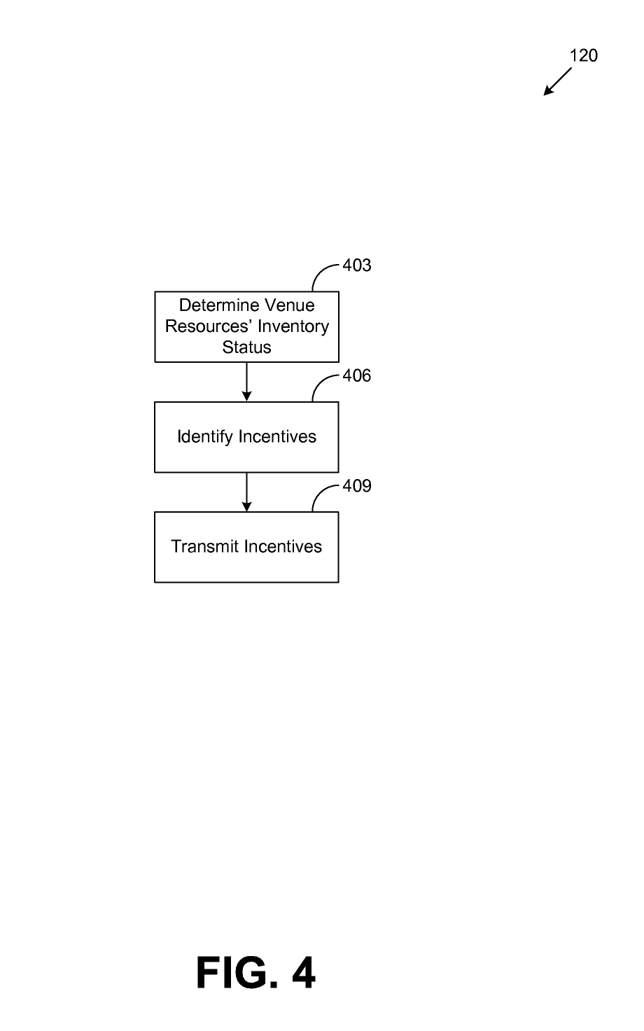

FIG. 4 is a flowchart illustrating exemplary functionality performed by an optimization service 174 (FIG. 1) according to certain embodiments. It is understood that the flowchart of FIG. 4 provides merely an example of the many different types of functional arrangements that may be employed to implement the operation of the optimization service 174 as described herein. As an alternative, the flowchart of FIG. 4 may be viewed as depicting an example of steps of a method implemented in the client device 120 (FIG. 1) according to one or more embodiments. It is further understood that steps of the present disclosure could be added, removed, altered, combined, and reordered without departing from the spirit and the scope of the present disclosure.

Beginning with step 403, the optimization service 174 determines the status of the inventory of the venue resources 156 (FIG. 1). In one embodiment, the optimization service 174 utilizes one or more predefined listings of the inventory status of venue resources 156, which may be stored on the data store 153 (FIG. 1) or another data store accessible to the optimization service 174. In another embodiment, the optimization service 174 interfaces with one or more venue resource-specific services executed by one or more venue resource-specific servers configured to query the status of inventory of the venue resources 156 in real-time on a continuous basis. In yet another embodiment, the optimization service 174 interfaces with one or more venue resource-specific services executed by one or more venue resource-specific servers configured to query the status of inventory of the venue resources 156 on a periodic basis. Furthermore, the optimization service 174 may be executed to store the determined inventory status of the venue resources 156 in the data store 153 for future operations.

Next, in step 406, the optimization service 174 identifies one or more incentives that are associated with the inventory statuses of the venue resources 156. In one embodiment, the optimization service 174 utilizes one or more predefined listings of associated incentives and inventory statuses, which may be stored on the data store 153 or another data store accessible to the optimization service 174. In another embodiment, the optimization service 174 determines which incentives to associate with inventory statuses based at least in part on one or more venue-specific factors and participant-specific factors, including the inventory status of the venue resources 156, the capacity of the venue resources 156, the utilization of the venue resources 156, the positional relationship between the venue resources 156 and the client devices 120, one or more venue preferences 171 (FIG. 1), and one or more participant preferences 132 (FIG. 1).

Then, in step 409, the optimization service 174 transmits one or more incentives to one or more client devices 120 associated with venue participants. As disclosed with regard to FIG. 1, the optimization service 174 may be executed to associate and disassociate client devices 120 with venue participants based on predefined listings, data transmissions, and the current positional relationship between the client devices 120 and the circumscribed venue. Furthermore, the optimization service 174 may utilize data transmissions to confirm that client devices 120 should be associated or disassociated with venue participants. As additionally disclosed with regard to FIG. 1, the optimization service 174 may be configured to transmit the incentives to the client devices 120 by utilizing one or more security protocols, measures, and applications, such as HTTPS, VPN, secure containers, and secure web-based access. In another embodiment, the optimization service 174 may be configured to transmit the incentives without enabling security protocols, measures, or applications, such as by utilizing SMS or MMS data transmission protocols.

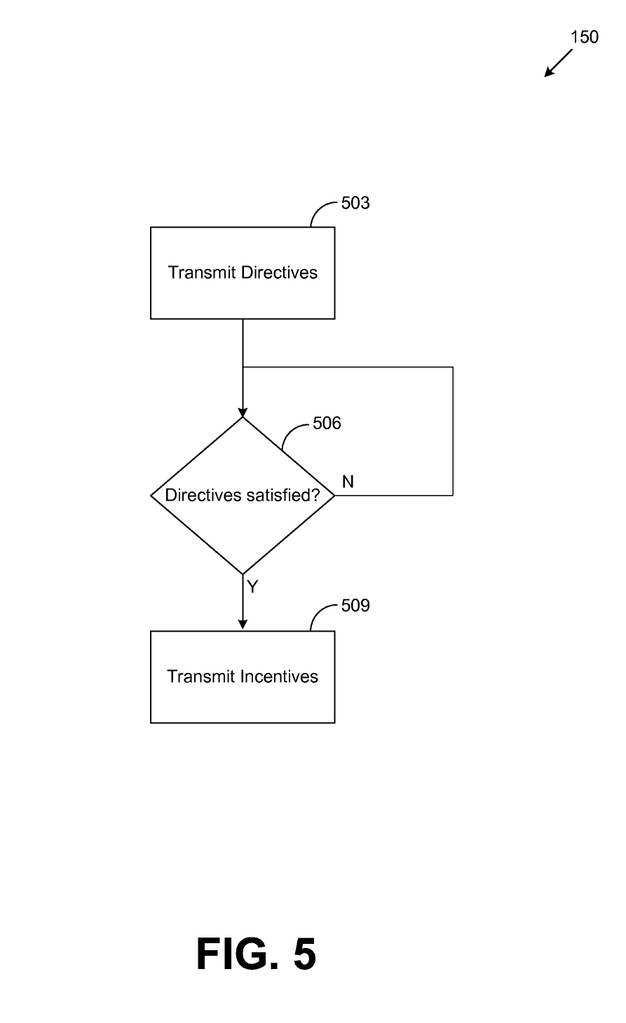

FIG. 5 is a flowchart illustrating exemplary functionality performed by an optimization service 174 (FIG. 1) according to certain embodiments. It is understood that the flowchart of FIG. 5 provides merely an example of the many different types of functional arrangements that may be employed to implement the operation of the optimization service 174 as described herein. As an alternative, the flowchart of FIG. 5 may be viewed as depicting an example of steps of a method implemented in the client device 120 (FIG. 1) according to one or more embodiments. It is further understood that steps of the present disclosure could be added, removed, altered, combined, and reordered without departing from the spirit and the scope of the present disclosure.

Beginning with step 503, the optimization service 174 transmits one or more directives to one or more client devices 120 associated with one or more venue participants of a circumscribed venue. In one embodiment, the directives comprise authorization requirements for receiving a distribution of one or more incentives associated with venue resources 156 (FIG. 1). More specifically, the directives may comprise a listing of tasks associated with venue resources 156 that must be completed by a venue participant before the optimization service 174 is authorized to distribute incentives to the venue participant's client device 120. Furthermore, the directives may merely require the satisfaction of a task or may require the satisfaction of the task in a certain manner, such as completing the task within a specific durational period. The directives may be based at least in part on one or more of the inventory status of the venue resources 156, the resource capacity (FIG. 1) of the venue resources 156, the resource utilization 168 (FIG. 1) of the venue resources 156, the positional relationship between the venue resources 156 and the client devices 120, one or more venue preferences 171 (FIG. 1), and one or more participant preferences (FIG. 1). The directives may include, for example, an instruction for the venue participant to access a specific venue resource 156 with a low utilization rate. The directives may be stored in the data store 153 (FIG. 1) of the optimization server 150 or another storage medium accessible to the optimization service 174. As disclosed with regard to FIG. 1, the optimization service 174 may be configured to transmit the directives to the client devices 120 by utilizing one or more security protocols, measures, and applications, such as HTTPS, VPN, secure containers, and secure web-based access. In another embodiment, the optimization service 174 may be configured to transmit the directives without enabling security protocols, measures, or applications, such as by utilizing SMS or MMS data transmission protocols.

Next, in step 506, the optimization server 174 determines which client devices 120 have satisfied one or more directives. In one embodiment, the optimization service 174 determines whether the client devices 120 to which the optimization service 174 previously distributed directives have satisfied the directives. In another embodiment, the optimization service 174 determines whether any client devices 120 associated with venue participants have satisfied the directives, regardless of whether the optimization service 174 transmitted the directives to the client devices 120. For example, the optimization service 174 may be configured to determine whether client devices 120 have accessed a specific venue resource 156 with the lowest utilization rate. Under such a scenario, the venue participant associated with a client device 120 may have independently chosen to access the under-utilized venue resource 156. Regardless of the venue participant's intentions, the optimization service 174 will determine that such client device 120 has satisfied the directives required for a distribution of incentives. In yet another embodiment, upon determining that a client device 120 has failed to satisfy the directives, the optimization service 174 may be configured to further determine whether the client device 120 satisfies the directives. The optimization service 174 may be configured, for example, to check the status of a client device's 120 compliance with the directives every fifteen minutes until the optimization service 174 determines that the client device 120 has satisfied the directives.

Then, in step 509, responsive to a determination that one or more recipient client devices 120 have satisfied the directives, the optimization service 174 transmits one or more incentives to the recipient client devices 120. As disclosed with regard to the transmission of directives, the optimization service 174 may be configured to transmit the incentives to the client devices 120 by utilizing one or more security protocols, measures, and applications, such as HTTPS, VPN, secure containers, and secure web-based access. In another embodiment, the optimization service 174 may be configured to transmit the incentives without enabling security protocols, measures, or applications, such as by utilizing SMS or MMS data transmission protocols.

In another embodiment, a client device 120 must satisfy a series of directives before the optimization service 174 is authorized to distribute the associated incentives to the client device 120. For example, responsive to a determination that a client device 120 has satisfied a first directive, the optimization service 174 may be configured to distribute a second directive to the client device 120, and so on. The optimization service 174 may further transmit a range of varying subsequent directives based on the manner of which the client device 120 satisfied the first directive transmitted. The client device 120 may, for instance, receive a complex second directive if the first directive was satisfied over long durational period, whereas the client device may receive a simple second directive if the first directive was satisfied in a short durational period. Then, responsive to a determination that the client device 120 has satisfied all subsequently transmitted directives, the optimization service 174 may be configured to transmit the associated incentives to the client device 120.

FIG. 6 shows schematic block diagrams of an exemplary optimization server 150 and an exemplary client device 120 according to an embodiment of the present disclosure. The optimization server 150 includes at least one processor circuit, for example, having a processor 603 and a memory 606, both of which are coupled to a local interface 609. To this end, the optimization server 150 may comprise, for example, at least one server computer or like device. Similarly, the client device 120 includes at least one processor circuit, for example, having a processor 613 and a memory 616, both of which are coupled to a local interface 619. Additionally, the client device 120 may be in data communication with a display 138 for rendering user interfaces 141 (FIG. 1) and one or more other I/O devices 622 for inputting and outputting data. To this end, the client device 120 may comprise, for example, at least one client computer or like device.

The following is a general discussion of the components of the optimization server 150 and the client device 120. The local interfaces 609 and 619 may comprise, for example, a data bus with an accompanying address/control bus or other bus structure as can be appreciated. Stored in the memories 606 and 616 are data and several components that are executable by the processors 603 and 613. In particular, with regard to the optimization server 150, stored in the memory 606 and executable by the processor 603 are an optimization service 174 and potentially other applications. Additionally, with regard to the client device 120, stored in the memory 616 and executable by the processor 613 are a client side application 135 and potentially other applications. Also stored in the memories 606 and 616 may be a data store 153 and 123, respectively, and other data. In addition, an operating system may be stored in the memories 606 and 616 and executable by the processors 603 and 613.

It is to be understood that there may be other applications that are stored in the memories 606 and 616 and are executable by the processors 603 and 613 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages now known or later developed.

A number of software components are stored in the memories 606 and 616 and are executable by the processors 603 and 613. In this respect, the term “executable” means a program file that is in a form that can ultimately be run by the processors 603 and 613. Examples of executable programs may be, for example, a compiled program that can be translated into machine code in a format that can be loaded into a random access portion of the memories 606 and 616 and run by the processors 603 and 613, source code that may be expressed in proper format such as object code that is capable of being loaded into a random access portion of the memories 606 and 616 and executed by the processors 603 and 613, or source code that may be interpreted by another executable program to generate instructions in a random access portion of the memories 606 and 616 to be executed by the processors 603 and 613, etc. An executable program may be stored in any portion or component of the memories 606 and 616 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components now known or later developed.

The memories 606 and 616 are defined herein as including both volatile and nonvolatile memory and data storage components. Volatile components are those that do not retain data values upon loss of power. Nonvolatile components are those that retain data upon a loss of power. Thus, the memories 606 and 616 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, a combination of any two or more of these memory components, and/or other memory components now known or later developed. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processors 603 and 613 may represent multiple processors, and the memories 606 and 616 may represent multiple memories that operate in parallel processing circuits, respectively. In such a case, the local interfaces 609 and 619 may be an appropriate network 110 (FIG. 1) that facilitates communication between any two of the multiple processors 603 and 613, or between any two of the memories 606 and 616, etc. The local interfaces 609 and 619 may comprise additional systems designed to coordinate this communication, including, for example, performing load balancing. The processors 603 and 613 may be of electrical or of some other available construction.

Although the optimization service 174 (FIG. 1), client side application 135, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Therefore, the following is claimed:

1. A computing device configured to execute a computer-based optimization service for influencing the utilization of resources in a circumscribed venue, the optimization service comprising:
logic for identifying one or more resources associated with a circumscribed venue;
logic for determining the optimal utilization of said venue resources; and,
logic for transmitting optimization data to one or more client devices associated with one or more venue participants.

2. The optimization service of claim 1, wherein said logic for identifying said venue resources comprises identifying which of said resources are within the circumscription of said circumscribed venue,
and wherein said cirumscription comprises a constraint selected from the group consisting of physical constraints, virtual constraints, economic constraints, and combinations thereof.

3. The optimization service of claim 1, wherein said logic for determining said optimal utilization comprises logic based at least in part on one or more of the inventory status of said venue resources, the capacity of said venue resources, the utilization of said venue resources, the positional relationship between said venue resources and said client devices, one or more venue preferences, and one or more participant preferences.

4. The optimization service of claim 3, wherein said inventory status comprises at least one or more of indications of the associated venue resource's total storage capacity, total storage utilization, quantities of inventory stored, types of inventory stored, and traits of inventory stored; and,
wherein said inventory types comprise at least one or more of raw material inventory, WIP (work-in-process) inventory, finished good inventory, merchandise inventory, manufacturing inventory, purchased inventory, consumable inventory, transit inventory, buffer inventory, anticipatory inventory, decoupling inventory, cycle inventory, MRO (maintenance, repair, and operating) inventory, and theoretical inventory;
wherein said inventory traits comprise at least one or more of the current position of said inventory, ownership of said inventory, availability of said inventory, expiration dates of said inventory, effective dates of said inventory, and handling requirements associated with said inventory;
wherein said venue preferences comprise at least one or more of business considerations, legal considerations, and economic considerations; and,
wherein said participant preferences comprise at least one or more of said venue participant's and other members of said venue participant's parties' age, gender, bodily traits, preferred resource types, and preferred venue resources.

5. The optimization service of claim 1, wherein said logic for transmitting said optimization data comprises determining which optimization data to transmit to said client devices based at least in part on said optimal utilization of said venue resources.

6. The optimization service of claim 1, wherein said optimization data comprises at least one or more of an indication of a venue resource, an indication of a venue resource's traits, an access requirement associated with a venue resource, an incentive associated with a venue resource, a directive associated with an incentive, and combinations thereof.

7. The optimization service of claim 1, wherein said optimization service is executed upon receiving one or more data communications from said client devices,
wherein said data communications comprise at least one or more of an indication of the current position of the associated client device, a transmission of a device profile of the associated client device, a client device request for optimization data, a client device request to register with said optimization service, and combinations thereof.

8. A computer-based method for influencing the utilization of resources in a circumscribed venue, the method comprising:
transmitting, from one or more client devices associated with one or more participants of a circumscribed venue, one or more data communications to a computer-based optimization service;
receiving, on said client devices, optimization data associated with one or more venue resources; and,
rendering said optimization data on said client devices.

9. The method of claim 8, wherein said venue resources are resources within the circumscription of said circumscribed venue, and
wherein said circumscription comprises a constraint selected from the group consisting of physical constraints, virtual constraints, economic constraints, and combinations thereof.

10. The method of claim 8, wherein said data communications comprise at least one or more of an indication of the current position of the associated client device, a transmission of a device profile of the associated client device, a client device request for optimization data, a client device request to register with said optimization service, and combinations thereof.

11. The method of claim 8, wherein said optimization data is based at least in part on the optimal utilization of said venue resources,
wherein said optimal utilization is based at least in part on one or more of the inventory status of said venue resources, the capacity of said venue resources, the utilization of said venue resources, the positional relationship between said venue resources and said client devices, one or more venue preferences, and one or more participant preferences.

12. The method of claim 11, wherein said inventory status comprises at least one or more of indications of the associated venue resource's total storage capacity, total storage utilization, quantities of inventory stored, types of inventory stored, and traits of inventory stored; and,
wherein said inventory types comprise at least one or more of raw material inventory, WIP (work-in-process) inventory, finished good inventory, merchandise inventory, manufacturing inventory, purchased inventory, consumable inventory, transit inventory, buffer inventory, anticipatory inventory, decoupling inventory, cycle inventory, MRO (maintenance, repair, and operating) inventory, and theoretical inventory; and,
wherein said inventory traits comprise at least one or more of the current position of said inventory, ownership of said inventory, availability of said inventory, expiration dates of said inventory, effective dates of said inventory, and handling requirements associated with said inventory;
wherein said venue preferences comprise at least one or more of business considerations, legal considerations, and economic considerations; and,
wherein said participant preferences comprise at least one or more of said venue participant's and other members of said venue participant's parties' age, gender, bodily traits, preferred resource types, and preferred venue resources.

13. The method of claim 8, wherein said optimization data comprises at least one or more of an indication of a venue resource, an indication of a venue resources' traits, an access requirement associated with a venue resource, an incentive associated with a venue resource, a directive associated with an incentive, and combinations thereof.

14. The method of claim 8, wherein said rendering of said optimization data comprises providing access to said optimization data for said venue participants through one or more user interfaces executed on said client devices.

15. The method of claim 14, wherein said rendering of said optimization data further comprises displaying one or more characters commercially associated with said circumscribed venue on said client device user interfaces.

16. A non-transitory computer-readable medium embodying a program executable in a computing device for influencing the utilization of resources in a circumscribed venue, the medium comprising:
code that determines the status of the inventory of one or more resources associated with a circumscribed venue;
code that identifies one or more incentives based at least in part on said inventory status of said venue resources; and,
code that transmits said incentives to one or more client devices associated with one or more participants of said circumscribed venue.

17. The medium of claim 16, wherein said resources and said client devices are associated with said circumscribed venue if said resources and said client devices are within the circumscription of said circumscribed venue,
wherein said circumscription comprises a constraint selected from the group consisting of physical constraints, virtual constraints, economic constraints, and combinations thereof.

18. The medium of claim 16, wherein said inventory status comprises at least one or more of indications of the associated venue resource's total storage capacity, total storage utilization, quantities of inventory stored, types of inventory stored, and traits of inventory stored; and,
wherein said inventory types comprise at least one or more of raw material inventory, WIP (work-in-process) inventory, finished good inventory, merchandise inventory, manufacturing inventory, purchased inventory, consumable inventory, transit inventory, buffer inventory, anticipatory inventory, decoupling inventory, cycle inventory, MRO (maintenance, repair, and operating) inventory, and theoretical inventory; and,
wherein said inventory traits comprise at least one or more of the current position of said inventory, ownership of said inventory, availability of said inventory, expiration dates of said inventory, effective dates of said inventory, and handling requirements associated with said inventory.

19. The medium of claim 16, wherein said incentives are further based at least in part on one or more of the capacity of said venue resources, the utilization of said venue resources, the positional relationship between said venue resources and said client devices, one or more venue preferences, and one or more participant preferences; and,
wherein said venue preferences comprise at least one or more of business considerations, legal considerations, and economic considerations; and,
wherein said participant preferences comprise at least one or more of said venue participant's and other members of said venue participant's parties' age, gender, bodily traits, preferred resource types, and preferred venue resources.

20. The medium of claim 16, wherein said medium further comprises:
code that identifies one or more directives associated with said incentives;
code that transmits said directives to said client devices associated with said venue participants; and,
responsive to a determination that said directives are satisfied said client devices, code that transmits the associated incentives to said client devices.
